(19) United States
(12) Patent Application Publication
(10) Pub. No.: US 2006/0176959 A1
(43) Pub. Date: Aug. 10, 2006

(54) Method and system for encoding variable length code (VLC) in a microprocessor

(76) Inventors: Paul Lu, Los Altos, CA (US); Weiping Pan, San Jose, CA (US)

Correspondence Address: MCANDREWS HELD & MALLOY, LTD, 500 WEST MADISON STREET, SUITE 3400, CHICAGO, IL, 60661, US

(21) Appl. No.: 11/052,170

(22) Filed: Feb. 7, 2005

(51) Int. Cl. H04N 11/04; H04B 1/66; H04N 11/02; H04N 7/12

(52) U.S. Cl. 375/240.23

(57) ABSTRACT

Methods and systems for processing video data are provided herein and may comprise receiving input video information to be processed and matching a portion of the received input video information against a portion of stored indexed video information entries having a corresponding variable length code whose length varies among stored indexed video information entries. An output encoded bitstream may be generated utilizing a portion of the variable length code corresponding to the matched portion of the indexed video information to be processed. The indexed video information entries may be stored in a content addressable memory (CAM). Each bit of the indexed video information entries may be stored utilizing a content bit and/or a “don't care” indicator bit.

### CROSS-REFERENCE TO RELATED APPLICATIONS/INCORPORATION BY REFERENCE

This application is related to the following applications:
U.S. patent application Ser. No.______ (Attorney Docket No. 16036US01), filed Feb. 07, 2005, and entitled “Method And System For Image Processing In A Microprocessor For Portable Video Communication Devices”;
U.S. patent application Ser. No.______ (Attorney Docket No. 16099US01), filed Feb. 07, 2005, and entitled “Method And System For Video Compression And Decompression (CODEC) In A Microprocessor”;
U.S. patent application Ser. No.______ (Attorney Docket No. 16232US02), filed Feb. 07, 2005, and entitled “Method And System For Video Motion Processing In A Microprocessor;” and
U.S. patent application Ser. No.______ (Attorney Docket No. 16471US01), filed Feb. 07, 2005, and entitled “Method And System For Decoding Variable Length Code (VLC) In A Microprocessor.”

The above stated patent applications are hereby incorporated herein by reference in their entirety.

### BACKGROUND OF THE INVENTION

Video compression and decompression techniques, as well as different image size standards, are utilized by conventional video processing systems, such as portable video communication devices, during recording, transmission, storage, and playback of video information. For example, quarter common intermediate format (QCIF) may be utilized for playback and recording of video information, such as videoconferencing, utilizing portable video communication devices, for example, portable video telephone devices. The QCIF format is an option provided by the ITU-T's H.261 standard for videoconferencing codes. It produces a color image of 144 non-interlaced luminance lines, each containing 176 pixels to be sent at a certain frame rate, for example, 15 frames per second (fps). QCIF provides approximately one quarter the resolution of the common intermediate format (CIF) with resolution of 288 luminance (Y) lines each containing 352 pixels.

In addition, common intermediate format (CIF) and video graphics array (VGA) format may be utilized for high quality playback and recording of video information, such as camcorder. The CIF format is also an option provided by the ITU-T's H.261/P×64 standard. It may produce a color image of 288 non-interlaced luminance lines, each containing 352 pixels to be sent at a certain frame rate, for example, 30 frames per second (fps). The VGA format supports a resolution of 640×480 pixels and is the most common display size used in the PC world.

Conventional video processing systems for portable video communication devices, such as video processing systems implementing the QCIF, CIF, and/or VGA formats, may utilize video encoding and decoding techniques to compress video information during transmission, or for storage, and to decompress elementary video data prior to communicating the video data to a display. The video compression and decompression (CODEC) techniques, such as variable length coding (VLC), in conventional video processing systems for portable video communication devices utilize a significant part of the computing resources of a general purpose central processing unit (CPU) of a microprocessor, or other embedded processor, for processing and transferring video data during encoding and/or decoding. The general purpose CPU, however, handles other real-time processing tasks, such as communication with other modules within a video processing network during a video teleconference utilizing the portable video communication devices, for example. The increased amount of computation-intensive video processing tasks and data transfer tasks executed by the CPU and/or other processor, in a conventional QCIF, CIF, and/or VGA video processing system results in a significant decrease in the video quality that the CPU or processor can provide for the video processing network.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for processing video data, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary VLC video encoding system that may be utilized in connection with an aspect of the invention.

FIG. 2 is a block diagram of the exemplary microprocessor architecture for video compression and decompression utilizing a coprocessor, in accordance with an embodiment of the invention.

FIG. 3 is a block diagram of an exemplary coprocessor for variable length code (VLC) processing, in accordance with an embodiment of the invention.

FIG. 4 is a block diagram of a table look-up (TLU) module within a coprocessor for VLC processing, in accordance with an embodiment of the invention.

FIG. 5 is a block diagram of a bitstream handler (BSH) module within a coprocessor for VLC processing, in accordance with an embodiment of the invention.

FIG. 6 is a block diagram of a table look-up (TLU) module utilized for VLC encoding, in accordance with an embodiment of the invention.

FIG. 7 is a block diagram of a table look-up (TLU) module utilized for VLC encoding with multiple encoding tables, in accordance with an embodiment of the invention.

FIG. 8 is a flow diagram of an exemplary method for VLC encoding, in accordance with an embodiment of the invention.

### DETAILED DESCRIPTION OF THE INVENTION

Certain aspects of the invention may be found in a method and system for processing of video data. In one aspect of the invention, computation-intensive video processing, such as variable length code (VLC) encoding, may be offloaded from a general purpose central processing unit (CPU) to a coprocessor. The coprocessor may comprise a table look-up (TLU) module with a plurality of on-chip memories, such as RAM, and may be adapted to store one or more entries from a VLC encoding table. For example, an on-chip memory may be utilized to store a VLC code entry and another on-chip memory may be utilized to store the corresponding VLC code entry attributes that each code may represent, such as LAST, RUN, and LEVEL entries. In addition, a bitstream handler (BSH) module may also be utilized within the coprocessor to manage generation of the encoded bitstream during encoding. In another aspect of the invention, the TLU module within the coprocessor may be adapted to store VLC code entries and corresponding VLC code attributes that each code may represent from a plurality of VLC definition tables. Accordingly, each VLC code entry and/or the corresponding attributes may comprise a VLC definition table identifier.

U.S. application Ser. No.______ (Attorney Docket No. 16471US01) filed on even date herewith discloses a method and system for decoding variable length code (VLC) in a microprocessor and is hereby incorporated herein by reference in its entirety.

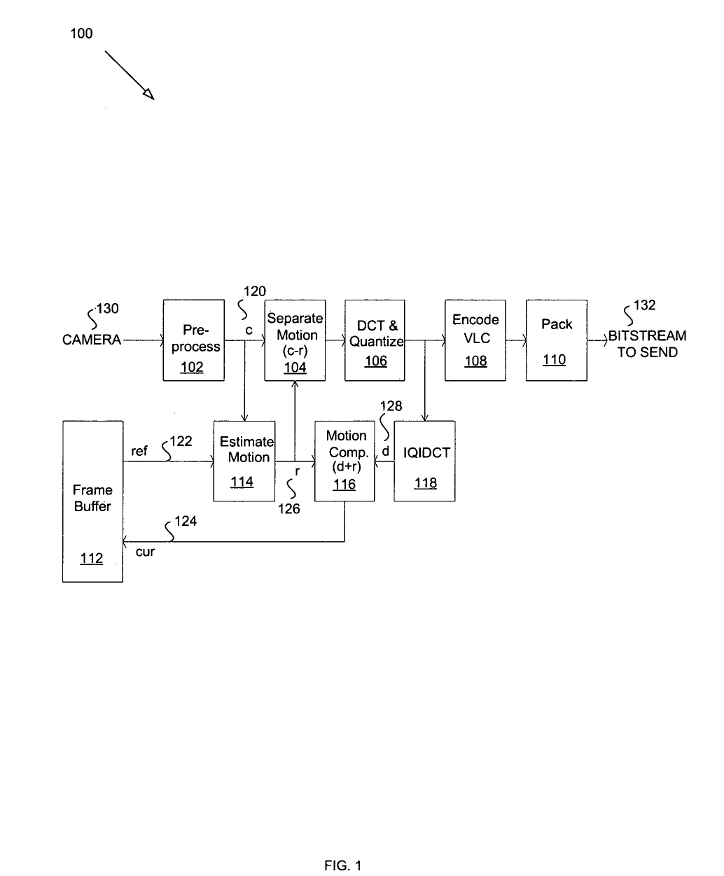

FIG. 1 is a block diagram of an exemplary VLC video encoding system that may be utilized in connection with an aspect of the invention. Referring to FIG. 1, the VLC video encoding system 100 may comprise a pre-processor 102, a motion separation module 104, a discrete cosine transformer and quantizer module 106, a variable length code (VLC) encoder 108, a packer 110, a frame buffer 112, a motion estimator 114, a motion compensator 116, and an inverse quantizer and inverse discrete cosine transformer (IQIDCT) module 118.

The pre-processor 102 comprises suitable circuitry, logic, and/or code and may be adapted to acquire video information from the camera 130 and convert the acquired camera video information to a YUV format suitable for encoding. The motion estimator 114 comprises suitable circuitry, logic, and/or code and may be adapted to acquire a current macroblock and its motion search area to determine an optimal motion reference from the acquired motion search area for use during motion separation and/or motion compensation, for example. The motion separation module 104 comprises suitable circuitry, logic, and/or code and may be adapted to acquire a current macroblock and its motion reference and determine one or more prediction errors based on the difference between the acquired current macroblock and its motion reference.

The discrete cosine transformer and quantizer module 106 and the IQIDCT module 118 comprise suitable circuitry, logic, and/or code and may be adapted to transform the prediction errors to frequency coefficients and the frequency coefficients back to prediction errors. For example, the discrete cosine transformer and quantizer module 106 may be adapted to acquire one or more prediction errors and apply a discrete cosine transform and subsequently quantize the acquired prediction errors to obtain frequency coefficients. Similarly, the IQIDCT module 118 may be adapted to acquire one or more frequency coefficients and apply an inverse quantize and subsequently inverse discrete cosine transform the acquired frequency coefficients to obtain prediction errors.

The motion compensator 116 comprises suitable circuitry, logic, and/or code and may be adapted to acquire a prediction error and its motion reference and to reconstruct a current macroblock based on the acquired prediction error and its motion reference. The VLC encoder 108 and the packer 110 comprise suitable circuitry, logic, and/or code and may be adapted to generate an encoded elementary video stream based on prediction motion information and/or quantized frequency coefficients. For example, prediction motion from one or more reference macroblocks may be encoded together with corresponding frequency coefficients to generate the encoded elementary bitstream. In one aspect of the invention, to increase the processing efficiency within the video encoding system 100, the VLC encoder 108 may be implemented in a coprocessor utilizing one or more memory modules to store VLC code and/or corresponding video attributes the VLC code may represent. The coprocessor may also comprise a bitstream handler (BSH) module, which may be utilized to manage generation of the encoded bitstream during encoding. In addition, the BSH module may be implemented as a tightly coupled extension of a central processor within the VLC video decoding system.

In operation, the pre-processor 102 may acquire video data from the camera 130, such as QCIF video data, and may convert the acquired camera video data to a YUV format suitable for encoding. A current macroblock 120 may then be communicated to both the motion separation module 104 and the motion estimator 114. The motion estimator 114 may acquire one or more reference macroblocks 122 from the frame buffer 112 and may determine the motion reference 126 corresponding to the current macroblock 120. The motion reference 126 may then be communicated to both the motion separation module 104 and the motion compensator 116.

The motion separation module 104, having acquired the current macroblock 120 and its motion reference 126, may generate a prediction error based on a difference between the current macroblock 120 and its motion reference 126. The generated prediction error may be communicated to the discrete cosine transformer and quantizer module 106 where the prediction error may be transformed into one or more frequency coefficients by applying a discrete cosine transformation and a quantization process. The generated frequency coefficients may be communicated to the VLC encoder 108 and the packer 110 for encoding into the bitstream 132. The bitstream 132 may also comprise one or more VLC codes corresponding to the quantized frequency coefficients.

The frequency coefficients generated by the discrete cosine transformer and quantizer module 106 may be communicated to the IQIDCT module 118. The IQIDCT module 118 may transform the frequency coefficients back to one or more prediction errors 128. The prediction errors 128, together with its motion reference 126, may be utilized by the motion compensator 116 to generate a reconstructed current macroblock 124. The reconstructed macroblock 124 may be stored in the frame buffer 112 and may be utilized as a reference for macroblocks in the subsequent frame generated by the pre-processor 102.

Referring to FIG. 1, in one aspect of the invention, one or more on-chip accelerators may be utilized to offload computation-intensive tasks from the CPU during encoding of video data. For example, one accelerator may be utilized to handle motion related computations, such as motion estimation, motion separation, and/or motion compensation. A second accelerator may be utilized to handle computation-intensive processing associated with discrete cosine transformation, quantization, inverse discrete cosine transformation, and inverse quantization. Another on-chip accelerator may be utilized to handle pre-processing of camera data to YUV format for encoding. Furthermore, one or more on-chip memory (OCM) modules may be utilized to improve access time that may be required to access data in the external memory during video data encoding. For example, an OCM module may be utilized for storing QCIF-formatted video data and for buffering one or more video frames that may be utilized during encoding. In addition, the OCM module may also comprise buffers for storing intermediate computational results during encoding, such as discrete cosine transformation (DCT) coefficients and/or prediction error information.

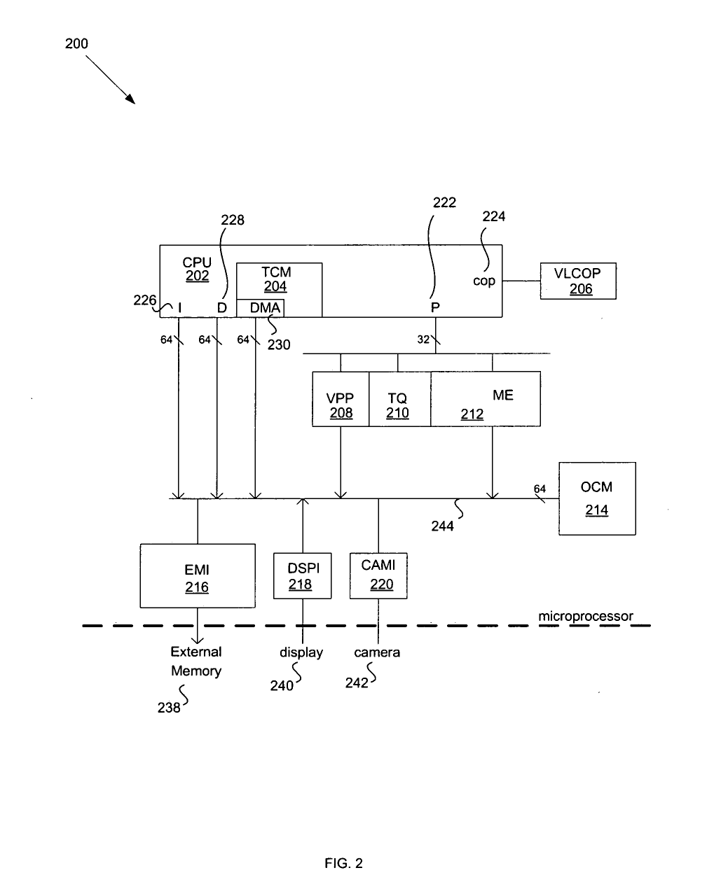

FIG. 2 is a block diagram of the exemplary microprocessor architecture for video compression and decompression utilizing a coprocessor, in accordance with an embodiment of the invention. Referring to FIG. 2, the exemplary microprocessor architecture 200 may comprise a central processing unit (CPU) 202, a variable length code coprocessor (VLCOP) 206, a video pre-processing and post-processing (VPP) accelerator 208, a transformation and quantization (TQ) accelerator 210, a motion estimating (ME) accelerator 212, an on-chip memory (OCM) 214, an external memory interface (EMI) 216, a display interface (DSPI) 218, and a camera interface (CAMI) 242. The EMI 216, the DSPI 218, and the CAMI 220 may be utilized within the microprocessor architecture 200 to access the external memory 238, the display 240, and the camera 242, respectively.

The CPU 202 may comprise an instruction port 226, a data port 228, a peripheral device port 222, a coprocessor port 224, tightly coupled memory (TCM) 204, and a direct memory access (DMA) module 230. The instruction port 226 and the data port 228 may be utilized by the CPU 202 to, for example, communicate data processing commands and data via connections to the system bus 244 during encoding of video information.

The TCM 204 may be utilized within the microprocessor architecture 200 for storage and access to large amounts of data without compromising operating efficiency of the CPU 202. The DMA module 230 may be utilized in connection with the TCM 204 to transfer data from/to the TCM 204 during operating cycles when the CPU 202 is not accessing the TCM 204.

The CPU 202 may utilize the coprocessor port 224 to communicate with the VLCOP 206. The VLCOP 206 may be adapted to assist the CPU 202 by offloading certain variable length coding (VLC) encoding tasks. For example, the VLCOP 206 may be adapted to utilize techniques, such as code table look-up and/or packing/unpacking of an elementary bitstream, to work with CPU 202 on a cycle-by-cycle basis. In one aspect of the invention, the VLCOP 206 may comprise a table look-up (TLU) module with a plurality of on-chip memories, such as RAM, and may be adapted to store entries from one or more VLC definition tables. For example, an on-chip memory may be utilized by the VLCOP 206 to store a VLC code entry and another on-chip memory may be utilized to store corresponding description attributes the code may represent. In addition, a bitstream handler (BSH) module may also be utilized within the VLCOP 206 to manage generation of the encoded bitstream during encoding. In another aspect of the invention, the TLU module within the coprocessor may be adapted to store VLC code entries and corresponding description attributes from a plurality of VLC definition tables. Accordingly, each VLC code entry and/or description attributes entry may comprise a VLC definition table identifier.

The OCM 214 may be utilized within the microprocessor architecture 200 during pre-processing of video data during compression. For example, the OCM 214 may be adapted to store pre-processed camera data communicated from the camera 242 via the VPP 208 prior to encoding of macroblocks.

In an exemplary aspect of the invention, the OCM 214 may comprise one or more frame buffers that may be adapted to store one or more reference frames utilized during encoding. In addition, the OCM 214 may comprise buffers adapted to store computational results and/or video data prior to encoding, such as DCT coefficients and/or prediction error information. The OCM 214 may be accessed by the CPU 202, the VPP accelerator 208, the TQ accelerator 218, the ME accelerator 212, the EMI 216, the DSPI 218, and/or the CAMI 220 via the system bus 244.

The CPU 202 may utilize the peripheral device port 222 to communicate with the on-chip accelerators VPP 208, TQ 210, and/or ME 212. The VPP accelerator 208 may comprise suitable circuitry and/or logic and may be adapted to provide video data pre-processing during encoding of video data within the microprocessor architecture 200. For example, the VPP accelerator 208 may be adapted to convert camera feed data to YUV-formatted video data prior to encoding.

The TQ accelerator 210 may comprise suitable circuitry and/or logic and may be adapted to perform discrete cosine transformation and quantization related processing of video data, including inverse discrete cosine transformation and inverse quantization. The ME accelerator 212 may comprise suitable circuitry and/or logic and may be adapted to perform motion estimation, motion separation, and/or motion compensation during encoding of video data within the microprocessor architecture 200. By utilizing the VLCOP 206, the VPP accelerator 208, the TQ accelerator 210, the ME accelerator 212, and the OCM 214 during encoding of video data, the CPU 202 may be alleviated from executing computation-intensive tasks associated with the encoding of video data.

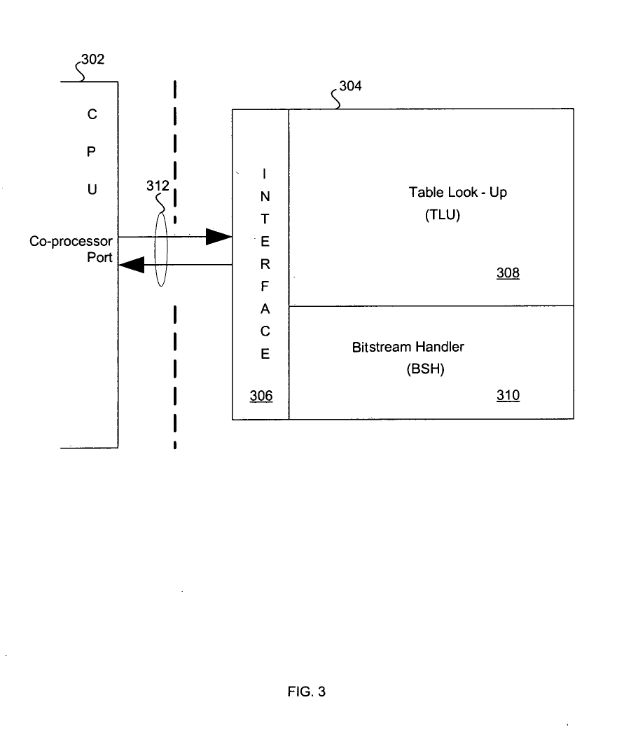

FIG. 3 is a block diagram of an exemplary coprocessor for variable length code (VLC) processing, in accordance with an embodiment of the invention. Referring to FIG. 3, the coprocessor 304 may comprise a CPU interface 306, a table look-up (TLU) module 308, and a bitstream handler (BSH) module 310. The CPU interface 302 may comprise suitable circuitry, logic, and/or code and may be adapted to receive information from, and/or communicate information between the CPU 302 from the TLU module 308 and the BSH module 310 via the connection with the CPU coprocessor port 312. The TLU module 308 and the BSH module 310 may be implemented as tightly coupled extensions of the CPU 302.

In one aspect of the invention, the CPU 302 within a video processing system may utilize the coprocessor 304 on a cycle-by-cycle basis to accelerate the encoding of video information utilizing VLC, for example. The TLU module 308 may comprise one or more on-chip memories, such as RAM, and may be adapted to store one or more entries from a VLC encoding table. For example, an on-chip memory within the TLU module may be utilized to store a VLC code entry and another on-chip memory may be utilized to store a corresponding description entry, such as a LAST, RUN, and LEVEL entry. The BSH module 310 may be utilized within the coprocessor 304 to manage generation of the encoded bitstream during encoding. In another aspect of the invention, the TLU module 308 within the coprocessor 304 may be adapted to store VLC code entries and corresponding description entries from a plurality of VLC definition tables. Accordingly, each VLC code entry and/or description entry may comprise a VLC definition table identifier.

In operation, during encoding, video attributes, such as LAST, RUN, and LEVEL entries, may be communicated from the CPU 302 to the BSH module 310 via the interface 306 and the connection 312. One or more VLC encoding tables may be loaded in the TLU module 308. For example, a first RAM in the TLU module 308 may store description entries and another memory may store corresponding VLC code entries. To find the VLC code of a description received from the CPU 302, the description from CPU may be matched against one or more of the description entries stored in the TLU module 308. If the description from CPU is matched against a description entry in the TLU module 308, the corresponding VLC code of the entry may be communicated to the BSH module 310 to be appended to an output encoded bitstream. The encoded bitstream may be communicated to the CPU 302 via the interface 306 and the connection 312.

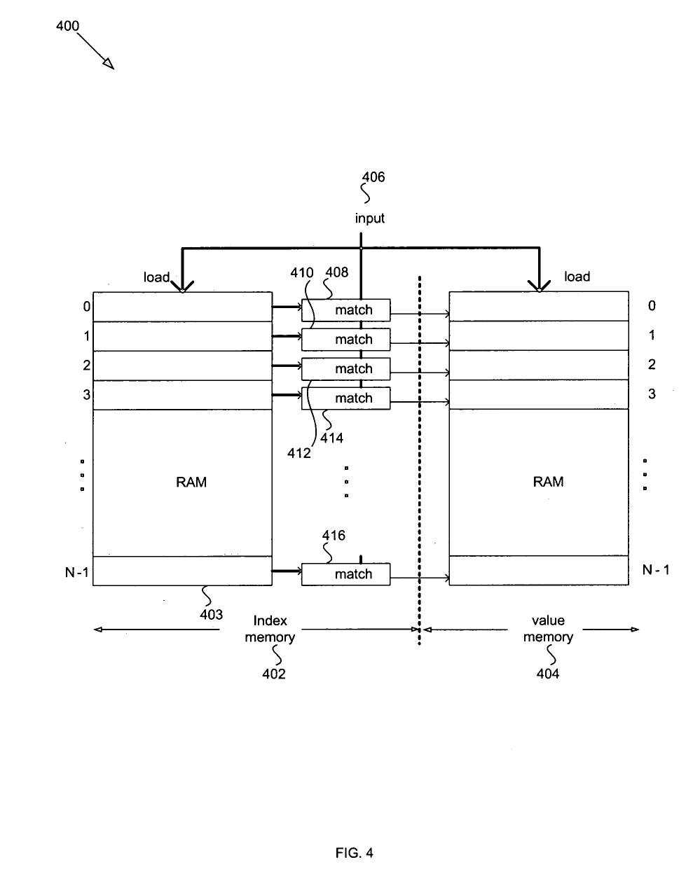

FIG. 4 is a block diagram of a table look-up (TLU) module within a coprocessor for VLC processing, in accordance with an embodiment of the invention. Referring to FIG. 4, the TLU module 400 may comprise an index memory 402 and a value memory 404. The index memory 402 may be implemented as a content addressable memory (CAM) and may comprise a content RAM 403 and matching modules 408 through 416. The content RAM 403 may comprise n number of entries, 0 through (N-1), each corresponding to matching circuitry 408 through 416 and entries 0 through (N-1) in the value memory 404, respectively. Each of the matching modules 408 through 416 may comprise suitable circuitry, logic, and/or code and may be adapted to compare an input entry received via the input signal 406 with a corresponding entry in the content RAM 403. If a match is detected, one or more of the matching modules 408 through 416 that detect the match, may be adapted to select the corresponding entry to output from the value memory 404.

In operation, the content RAM 403 and the value memory 404 may be loaded with VLC definition table entries via the input port 406. For example, the content RAM 403 may be loaded with n number of VLC description entries during encoding. In one aspect of the invention, each content bit in the content RAM 403 may comprise two RAM bits. One RAM bit may be utilized to store content and a second RAM bit may be utilized to store a “don't care” indicator for matching. During look-up and matching by the matching modules 408 through 416, if a “don't care” indicator is asserted, content from the corresponding content bit may be excused from selection in an output signal when the entry is bitwise matched against video information received via the input port 406. Similarly, if a “don't care” indicator is not asserted, content from the corresponding content bit may be bitwise matched against video information received via the input port 406.

Once VLC definition table entries are loaded in the content RAM 403 and the value RAM 404, an input video information received via the input port 406 may be communicated to the matching modules 408 through 416 for matching. During look-up, each of the matching module 408 through 416 may compare bitwise all bits in the input video information for processing received via the input port 406 with all content bits in a corresponding content RAM 403 entry. For example, during encoding, a VLC description may be communicated to the TLU module 400 for matching by the matching modules 408 through 416 and a corresponding VLC code entry may be outputted from the TLU module 400 to a BSH module, for example.

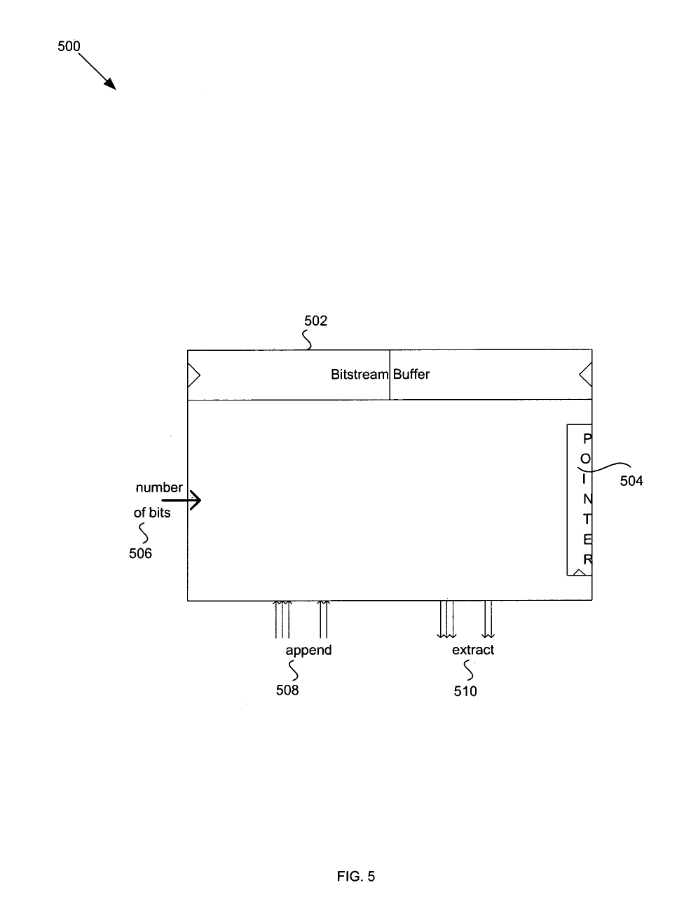

FIG. 5 is a block diagram of a bitstream handler (BSH) module within a coprocessor for VLC processing, in accordance with an embodiment of the invention. Referring to FIG. 5, the BSH module 500 may comprise a bitstream buffer 502 and a pointer 504. The bitstream buffer 502 may be adapted to store an encoded bitstream. During encoding, a CPU may communicate one or more VLC description entries, such as LAST, RUN, and LEVEL entries, for encoding by a coprocessor's TLU module, for example. After the TLU module matches the video information for processing against all VLC description entries and locates a corresponding VLC code, the TLU module may communicate the corresponding VLC code, together with the number of bits 506 in the VLC code to the BSH module 500. The VLC code 508 may be communicated to the bitstream buffer 502 together with an append command. After receiving the VLC code 508, the BSH module 500 may append the bitstream in the bitstream buffer 502 with the received VLC code 508 and may then move the pointer 504 by the corresponding bit number 506 of the appended VLC code. In an exemplary aspect of the invention, if the pointer 504 exceeds a determined maximum length, the accumulated bitstream may be communicated to the CPU and the pointer 504 may be reset.

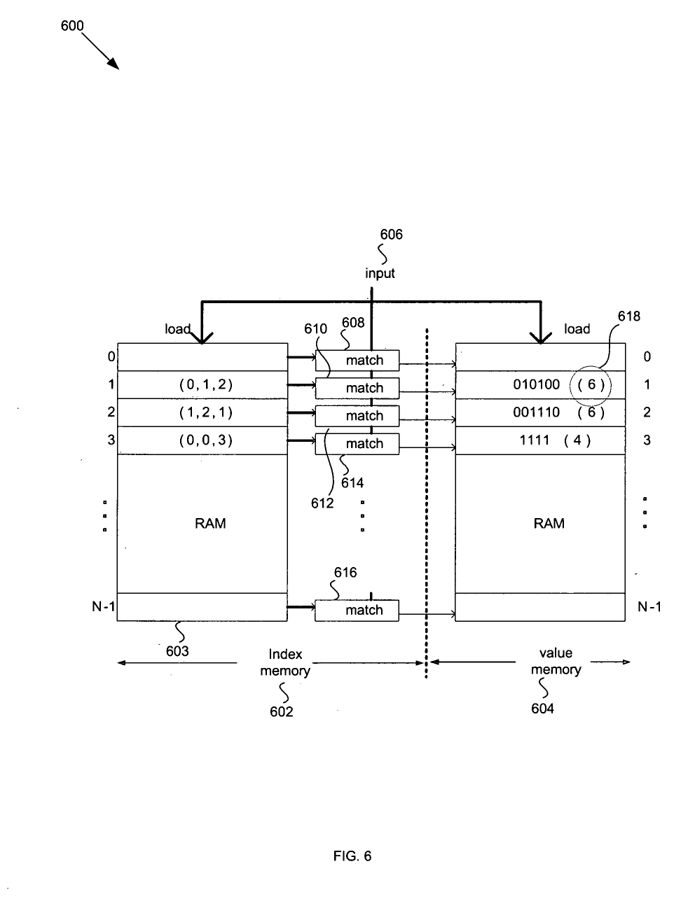

FIG. 6 is a block diagram of a table look-up (TLU) module utilized for VLC encoding, in accordance with an embodiment of the invention. Referring to FIG. 6, the TLU module 600 may comprise an index memory 602 and a value memory 604. The value memory 604 may comprise RAM, for example. The index memory 602 may be implemented as a content addressable memory (CAM) and may comprise a content RAM 603 and matching modules 608 through 616. The content RAM 603 may comprise n number of entries, 0 through (N-1), each corresponding to matching circuitry 608 through 616 and entries 0 through (N-1) in the value memory 604, respectively. Each of the matching modules 608 through 616 may comprise suitable circuitry, logic, and/or code and may be adapted to compare an input video information for processing received via the input port 606 with a corresponding entry in the content RAM 603. If a match is detected, each of the matching modules 608 through 616 may be adapted to output a corresponding entry from the value memory 604.

In operation, the content RAM 603 and the value RAM 604 may be loaded with VLC definition table entries via the input port 606. For example, during encoding, the content RAM 603 may be loaded with n number of VLC description entries, such as LAST, RUN, and LEVEL entries, and the value RAM 604 may be loaded with a corresponding n number of VLC code entries. In one aspect of the invention, each content bit in the content RAM 603 may comprise two RAM bits. One RAM bit may be utilized to store content and a second RAM bit may be utilized to store a “don't care” indicator for matching. During look-up and matching by the matching modules 608 through 616, if a “don't care” indicator is asserted, content from the corresponding content bit may be excused from selection in an output signal when the entry is bitwise compared with the video information received via the input port 606. Similarly, if a “don't care” indicator is not asserted, content from the corresponding content bit may be bitwise matched against the video information received via the input port 606.

In an exemplary aspect of the invention, each VLC code entry in the value RAM 604 may comprise a VLC code length indicator 618. For example, a LAST, RUN, and LEVEL entry of (0, 1, 2) from a VLC encoding table B-16 may be stored in memory entry one in the content RAM 603. A corresponding VLC code “010100” may be stored in memory entry one in the value RAM 604. However, a value “6” may be stored as VLC code length indicator 618 at the end of the VLC code “010100” indicating the VLC code length. During encoding, after a LAST, RUN, and LEVEL entry in the content RAM 603 is matched against a LAST, RUN, and LEVEL entry in the input video information received via the input port 606, a corresponding VLC code entry in the value RAM 604 may be communicated to a BSH module for further processing. In this regard, the value RAM 604 may communicate the entire content of the memory block comprising the matched VLC code to the BSH module. The BSH module, however, may utilize the VLC code length indicator so that only the VLC code bits and no insignificant symbols are read by the BSH module for processing. The VLC code length indicator for each matched VLC code entry may also be communicated to the BSH module so that a pointer within the BSH module may be adjusted according to the VLC code length after the corresponding VLC code is appended to a buffered bitstream.

Once VLC definition table entries are loaded in the content RAM 603 and the value RAM 604, an input VLC description entry received via the input port 606 may be communicated to the matching modules 608 through 616 for matching. The input VLC description entry received via the input port 606 may be communicated from a CPU and/or from a BSH module, for example, and may comprise one or more LAST, RUN, and LEVEL entries for encoding. During look-up, each of the matching modules 608 through 616 may compare the received LAST, RUN, and LEVEL entry bit-pattern with all content bits in a corresponding content RAM 603 entry. If a “don't care” bit within the content RAM 603 is asserted, the corresponding content bit may be ignored. The matching modules 608 through 616 may match the received LAST, RUN, and LEVEL entries with the LAST, RUN, and LEVEL entries in the content RAM 603. After a match is located, the corresponding VLC code entry from the value RAM 604 may be outputted from the TLU module 600 to a BSH module, for example, for further processing and appending to an encoded bitstream. The encoded bitstream may be communicated to the CPU for processing when the bitstream buffer is full, for example.

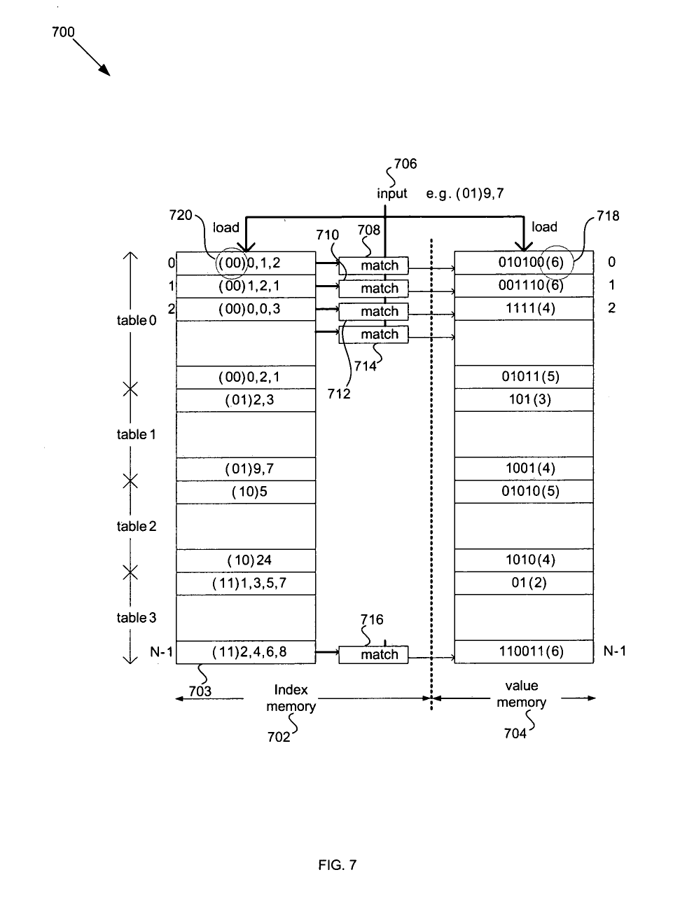

FIG. 7 is a block diagram of a table look-up (TLU) module utilized for VLC encoding with multiple definition tables, in accordance with an embodiment of the invention. Referring to FIG. 7, the TLU module 700 may comprise an index memory 702 and a value memory 704. The value memory 704 may comprise RAM, for example. The index memory 702 may be implemented as a content addressable memory (CAM) and may comprise a content RAM 703 and matching modules 708 through 716. The content RAM 703 may comprise n number of entries, 0 through (N-1), each corresponding to matching circuitry 708 through 716 and entries 0 through (N-1) in the value memory 704, respectively. Each of the matching modules 708 through 716 may comprise suitable circuitry, logic, and/or code and may be adapted to compare an input video information for processing received via the input port 706 with a corresponding entry in the content RAM 703. If a match is detected, one or more of the matching modules 708 through 716 that detect the match, may be adapted to select a corresponding entry for output from the value memory 704.

In operation, the content RAM 703 and the value RAM 704 may be loaded with VLC definition entries from a plurality of VLC encoding tables via the input port 706. For example, during encoding, the content RAM 703 may be loaded with n number of LAST, RUN, and LEVEL entries from four definition tables, and the value RAM 604 may be loaded with a corresponding n number of VLC code entries from the same four definition tables. In one aspect of the invention, each content bit in the content RAM 703 may comprise two RAM bits. One RAM bit may be utilized to store content and a second RAM bit may be utilized to store a “don't care” indicator for matching. During look-up and matching by the matching modules 708 through 716, if a “don't care” indicator is asserted, content from the corresponding content bit may be excused from selection in an output signal when the entry is bitwise compared with the VLC definition entries received via the input port 706. Similarly, if a “don't care” indicator is not asserted, or deasserted, content from the corresponding content bit may be bitwise matched against the VLC definition entries received via the input port 706.

In an exemplary aspect of the invention, each LAST, RUN, and LEVEL entry stored in the content RAM 703 may comprise a definition table indicator, such as table indicator 720. The definition table indicator may be appended by the CPU at the beginning of each LAST, RUN, and LEVEL entry that may be received via the input port 706 for storage in the content RAM 703. When an input LAST, RUN, and LEVEL entry is received for encoding, the CPU or BSH may append the corresponding definition table indicator to the input LAST, RUN, and LEVEL entry so that the TLU 700 may perform correct matching with LAST, RUN, and LEVEL entries of the intended definition table in the content RAM 703.

Each VLC code entry in the value RAM 704 may comprise a VLC code length indicator 718. For example, a LAST, RUN, and LEVEL entry of (00, 0, 1, 2) from a first VLC encoding table may be stored in memory entry one in the content RAM 703. A corresponding VLC code “010100” may be stored in memory entry one in the value RAM 704. However, a value “6” may be stored as VLC code length indicator 718 at the end of the VLC code “010100” indicating the VLC code length. During encoding, after a LAST, RUN, and LEVEL entry in the content RAM 703 is matched against a LAST, RUN, and LEVEL entry in the input port 706, a corresponding VLC code entry in the value RAM 704 may be communicated to a BSH module for further processing. In this regard, the value RAM 704 may communicate the entire content of the memory block comprising the matched VLC code to the BSH module. The BSH module, however, may utilize the VLC code length indicator so that only the VLC code bits and no insignificant symbols are read by the BSH module for processing. The VLC code length indicator for each matched VLC code entry may also be communicated to the BSH module so that a pointer within the BSH module may be adjusted according to the VLC code length after the corresponding VLC code is appended to a buffered bitstream.

Once VLC entries from multiple definition tables are loaded in the content RAM 703 and the value RAM 704, an input VLC description information received via the input port 706 may be communicated to the matching modules 708 through 716 for matching. The input VLC description information may be communicated from a CPU and/or from a BSH module, for example, and may comprise one or more LAST, RUN, and LEVEL attributes for encoding. Each communicated LAST, RUN, and LEVEL entry may comprise a definition table identifier. During look-up, each of the matching modules 708 through 716 may compare the received LAST, RUN, and LEVEL entry bit-pattern with all content bits in a corresponding content RAM 703 entry for a definition table corresponding to a received definition table identifier. If a “don't care” bit within the content RAM 703 is asserted, the corresponding content bit may be ignored. The matching modules 708 through 716 may match the received LAST, RUN, and LEVEL entry with one or more of the LAST, RUN, and LEVEL entries in the content RAM 703. After a match is located, the corresponding VLC code entry from the value RAM 704 may be outputted from the TLU module 700 to a BSH module, for example, for further processing and appending to an encoded bitstream. The encoded bitstream may be communicated to the CPU for processing when the bitstream buffer is full.

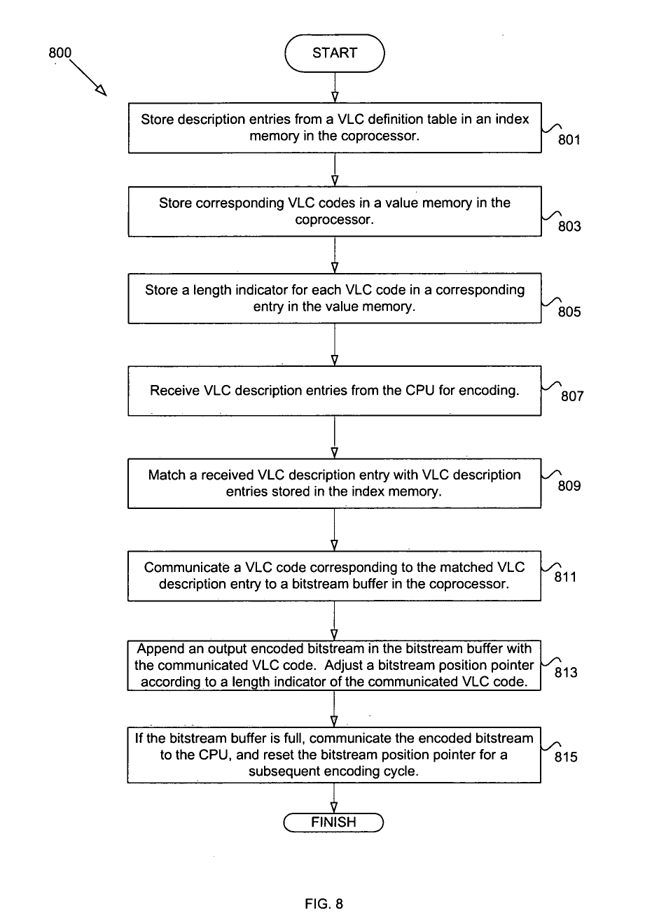

FIG. 8 is a flow diagram of an exemplary method 800 for VLC encoding, in accordance with an embodiment of the invention. Referring to FIG. 8, at 801, the description entries from a VLC definition table, which comprises one or more attributes such as (LAST, RUN, LEVEL), may be stored in an index memory in a coprocessor. At 803, corresponding VLC codes may be stored in a value memory, for example, in the coprocessor. At 805, a length indicator for each VLC code may also be stored in corresponding entries in the value memory. At 807, a VLC description entry may be received from the CPU for encoding. At 809, a received description entry may be matched against all VLC description entries stored in the index memory. At 811, a VLC code, corresponding to the matched VLC description entry, may be communicated to a bitstream buffer in the coprocessor. At 813, an output encoded bitstream in the bitstream buffer may be appended with the communicated VLC code. A bitstream position pointer may then be adjusted according to a length indicator of the communicated VLC code. At 815, if the bitstream buffer is full, the encoded bitstream may be communicated to the CPU, and the bitstream position pointer may be reset for a subsequent encoding cycle.

Accordingly, aspects of the invention may be realized in hardware, software, firmware or a combination thereof. The invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

Another embodiment of the present invention may be implemented as dedicated circuitry in an ASIC. The dedicated circuitry may work together with a general purpose processor in the ASIC to carry out the data transferring and calculation tasks according to the present invention. The partition of workload between the general purpose processor and the dedicated circuitry may be determined by system performance requirement and/or by cost considerations.

The invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for processing video data, the method comprising:
receiving input video information to be processed;
matching at least a portion of said received input video information to be processed against at least a portion of stored indexed video information entries having a corresponding variable length code whose length varies among stored indexed video information entries;
generating an output encoded bitstream utilizing at least a portion of said variable length code corresponding to said matched at least a portion of said indexed video information to be processed; and
offloading at least a portion of the matching and said output encoded bitstream generation to at least one on-chip coprocessor.

2. The method according to claim 1, further comprising storing said indexed video information entries in a content addressable memory (CAM).

3. The method according to claim 1, wherein each bit of said at least a portion of said indexed video information entries is stored utilizing at least one of a content bit and a “don't care” indicator bit.

4. The method according to claim 3, further comprising matching at least a portion of said received input video information to be processed against said at least a portion of said indexed video information entries, if at least one “don't care” indicator bit corresponding to said at least a portion of said indexed video information entries is not asserted.

5. The method according to claim 1, further comprising storing at least one variable length code length indicator for each of said variable length code.

6. The method according to claim 5, further comprising appending said output encoded bitstream with at least a portion of said variable length code corresponding to said stored at least one variable length code length indicator.

7. The method according to claim 1, wherein each of said stored indexed video information entries comprises at least one variable length code definition table indication bit, which corresponds to a variable length code definition table.

8. A machine-readable storage having stored thereon, a computer program having at least one code section for processing video data, the at least one code section being executable by a machine to perform steps comprising:
receiving input video information to be processed;
matching at least a portion of said received input video information to be processed against at least a portion of stored indexed video information entries having a corresponding variable length code whose length varies among stored indexed video information entries;
generating an output encoded bitstream utilizing at least a portion of said variable length code corresponding to said matched at least a portion of said indexed video information to be processed; and
offloading at least a portion of the matching and said output encoded bitstream generation to at least one on-chip coprocessor.

9. The machine-readable storage according to claim 8, further comprising code for storing said indexed video information entries in a content addressable memory (CAM).

10. The machine-readable storage according to claim 8, wherein each bit of said at least a portion of said indexed video information entries is stored utilizing at least one of a content bit and a “don't care” indicator bit.

11. The machine-readable storage according to claim 10, further comprising code for matching at least a portion of said received input video information to be processed against said at least a portion of said indexed video information entries, if at least one “don't care” indicator bit corresponding to said at least a portion of said indexed video information entries is not asserted.

12. The machine-readable storage according to claim 8, further comprising code for storing at least one variable length code length indicator for each of said variable length code.

13. The machine-readable storage according to claim 12, further comprising code for appending said output encoded bitstream with at least a portion of said variable length code corresponding to said stored at least one variable length code length indicator.

14. The machine-readable storage according to claim 8, wherein each of said stored indexed video information entries comprises at least one variable length code definition table indication bit, which corresponds to a variable length code definition table.

15. A system for processing video data, the system comprising:
at least one processor that receives input video information to be processed;
said at least one processor and at least one on-chip coprocessor match at least a portion of said received input video information to be processed against at least a portion of stored indexed video information entries having a corresponding variable length code whose length varies among stored indexed video information entries;
said at least one processor generates an output encoded bitstream utilizing at least a portion of said variable length code corresponding to said matched at least a portion of said indexed video information to be processed; and
said at least one processor offloads at least a portion of the matching and said output encoded bitstream generation to said at least one on-chip coprocessor.

16. The system according to claim 15, wherein said at least one processor stores said indexed video information entries in a content addressable memory (CAM).

17. The system according to claim 15, wherein each bit of said at least a portion of said indexed video information entries is stored utilizing at least one of a content bit and a “don't care” indicator bit.

18. The system according to claim 17, wherein said at least one processor and said at least one on-chip coprocessor match at least a portion of said received input video information to be processed against said at least a portion of said indexed video information entries, if at least one “don't care” indicator bit corresponding to said at least a portion of said indexed video information entries is not asserted.

19. The system according to claim 15, wherein said at least one processor stores at least one variable length code length indicator for each of said variable length code.

20. The system according to claim 19, further comprising a bitstream handler (BSH) module that appends said output encoded bitstream with at least a portion of said variable length code corresponding to said stored at least one variable length code length indicator.

21. The system according to claim 15, wherein each of said stored indexed video information entries comprises at least one variable length code definition table indication bit, which corresponds to a variable length code definition table.
